(19) United States
(12) Patent Application Publication
(10) Pub. No.: US 2011/0022766 A1
(43) Pub. Date: Jan. 27, 2011

(54) Circuit Arrangement For A Motor Vehicle Data Bus

(75) Inventors: Tobias Beckmann, Eschborn (DE); Roman Büchler, Frankfurt (DE); Wofgang Fey, Niedernhausen (DE)

Correspondence Address: RATNERPRESTIA, P.O. BOX 980, VALLEY FORGE, PA, 19482, US

(73) Assignee: Continental Teves AG & Co. oHG, Frankfurt (DE)

(21) Appl. No.: 12/522,602

(22) PCT Filed: Jan. 15, 2008
(86) PCT No.: PCT/EP08/50379

§ 371 Date: Jul. 9, 2009

(30) Foreign Application Priority Data
Jan. 17, 2007 (DE) 10 2007 003 326.7
Jan. 15, 2008 (DE) 10 2008 004 551.9

(51) Int. Cl. G06F 13/40

(52) U.S. Cl. 710/305

(57) ABSTRACT

Transmission and/or reception circuit arrangement for the physical implementation of a motor vehicle data bus system and use thereof, wherein the circuit has a plurality of configurable modes of operation which are a different physical implementation of one or more logic states and also comprises electronic bit generation and/or bit reception circuit elements which are used in each mode of operation, wherein changeover and/or structure elements are present which can be used to change over the circuit arrangement between the modes of operation and/or to operate said circuit arrangement in different modes of operation.

### CROSS REFERENCE TO RELATED APPLICATIONS

This application is the U.S. national phase application of PCT International Application No. PCT/EP2008/050379, filed Jan. 15, 2008, which claims priority to German Patent Application No. DE 102007003326.7, filed Jan. 17, 2007 and German Patent Application No. DE 102008004551.9, filed Jan. 15, 2008,the contents of such applications being incorporated by reference herein.

### BACKGROUND OF THE INVENTION

1. Field of the Invention

The invention relates to a transmission and/or reception circuit arrangement for the physical implementation of a motor vehicle data bus system and the use thereof in a motor vehicle controller.

2. Description of the Related Art

FlexRay(R) is a bus standard for electronic controllers in motor vehicles which is intended to allow particularly rapid, realtime-compatible and error-tolerant transmission of the data. FlexRay(R) is regarded by many leading motor vehicle manufacturers and their suppliers as the future standard which, at least in subdomains, is meant to replace the CanBus(R) data transmission technology used in practically all motor vehicles.

The CanBus(R) technology, or the network formed thereby, is used for the data interchange between the electronic controllers, sensors and actuators which are increasingly present in the vehicle. FlexRay(R) allows improved and faster data transmission in comparison with CAN essentially through the use of fixed time windows and error-tolerant and redundant transmission on two channels.

An electronic FlexRay(R) driver circuit (physical layer) based on the prior art essentially comprises two high-side and two low-side driver stages which can produce two different dominant, that is to say actively driven, states (inverted difference voltage) on the bus. Depending on the state “0” or “1”, a high-side driver and a low-side driver are respectively connected in series; the electrical connection between the drivers is formed by the connections on the bus lines BP and BM.

By contrast, a CAN driver is known to comprise just a high-side driver stage and a low-side driver stage, since only a dominant (actively driven) state needs to be produced. The output of the high-side driver is connected to the CAN-H bus line, and the output of the low-side driver is connected to the CAN-L bus line.

### SUMMARY OF THE INVENTION

An object of the present invention is now to specify a transmission and/or reception circuit for the physical implementation of a motor vehicle data bus which is flexibly configurable and of simple design.

In at least one aspect, the invention addresses the following problem: in order to be universally usable, controllers must frequently provide both a CAN bus connection and a FlexRay(R) connection. An inherently known FlexRay transceiver is usually larger and therefore more expensive than a CAN transceiver. The invention contains the idea that partially combining circuit elements from the two conventional CAN transceivers provides the opportunity to use the transceiver formed for a plurality of bus types, that is to say particularly CAN and FlexRay. Furthermore, one exemplary embodiment makes it possible to change between a FlexRay connection and two CAN connections.

In at least one aspect, the invention relates to a transmission circuit arrangement and/or a reception circuit arrangement for the physical implementation of a motor vehicle data bus system. Said circuit arrangement comprises terminals for the connection of a bus line which can be used to transmit bus data. The terminals are preferably connected to a CanBus or to a FlexRay bus. Furthermore, the circuit arrangement comprises output terminals to which, by way of example, a digital processing unit is connected which, by way of example, may be a microcontroller for processing the bus data. Logic levels are applied to the output terminals on the basis of the bus data which are to be sent or received. The circuit arrangement has, in particular, one or more control lines which can be used to configure the behavior of the circuit arrangement.

In addition, the circuit has a plurality of modes of operation with different physical implementations of one or more logic states (for example “0” or “1”). In this case, physical implementation is understood to mean the conversion of the binary states into electrical signals.

In addition, the circuit contains electronic bit generation and/or bit reception circuit elements which are used in each mode of operation. These common circuit elements, which are drivers and/or comparators, for example, can be used either in a first mode of operation or for a further, particularly second mode of operation.

Finally, the inventive circuit arrangement also contains changeover and/or structure means. By way of example, the changeover means can be used for mode changeover and/or configuration on the basis of the signals on the control line(s). To this end, the control lines are preferably connected to at least one appropriate control module. As explained further above, mode changeover and/or configuration can also be effected using structure means. Structure means refer to different external interconnections for the inputs and/or outputs of the circuit or else to wire bridges or the like, which can be subsequently soldered to the circuit by the user of the circuit, for example. Another example of a structure means is a control input or a bus input (for example SPI bus) of the circuit, which input can be used to change over the circuit to different modes of operation. To this end, particularly a memory (for example FlipFlop, EEPROM) is present on the circuit and stores the last programmed operating state.

The invention preferably defines a universal transceiver which, depending on the mode of operation, allows FlexRay(R) and/or CanBus(R) data communication.

In a controller which already has two or more CAN connections (and appropriate electronic transceiver elements therefore), it may be advantageous to provide a FlexRay connection instead of a CAN connection (or else both CAN connections). Since the transceiver electronics which belong to this FlexRay connection can also be operated as a CanBus, as shown above, this uses up less chip area, particularly when implemented on an integrated chip. This results in significant cost advantages for production in large quantities. The inventive driver or reception circuit is therefore particularly suitable for use as part of a user-specific circuit (ASIC), which is preferred, since normally these are produced in large quantities, which means that component savings are advantageous for economic reasons. An additional effect advantageously achieved is that pin compatibility between CAN mode and FlexRay(R) mode exists for the bus connections and the logic inputs and outputs.

### BRIEF DESCRIPTION OF THE DRAWINGS

Further advantages and features of the invention will be apparent from the following description of an exemplary embodiment with reference to figures, in which

FIG. 1 shows a block diagram with a driver node for operation in a FlexRay(R) network,

FIG. 2 shows a plurality of connection examples for terminals of a function block on a CAN or FlexRay(R) bus,

FIG. 3 shows a driver module with a function block as shown in FIG. 2,

FIG. 4 shows a receiver module with two modes of operation (CAN and FlexRay(R)),

FIG. 5 shows a further example of a receiver module which, like the receiver module in FIG. 4, can be used both for FlexRay(R) and for CAN and

FIG. 6 shows a conventional, commercially available FlexRay(R) standard chip (FlexRay(R) transceiver) which, by means of special actuation/interconnection, is used as a CAN chip.

### DETAILED DESCRIPTION OF THE PREFERRED EMBODIMENTS

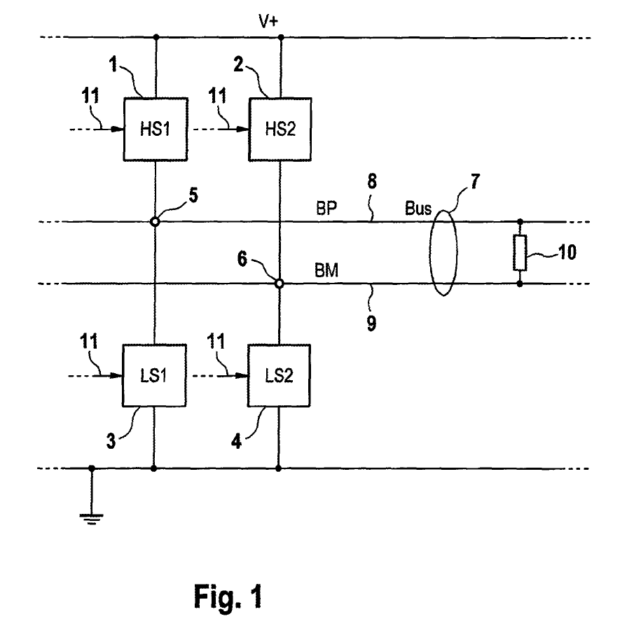

In FIG. 1, the drivers 1 . . . 4 (HS1, HS2, LS1, LS2) form a network node which is connected by means of terminals 5 and 6 to data bus 7. Bus 7 comprises the bus lines 8 (BP) and 9 (BM) of a FlexRay(R) network. Bus 7 has further bus subscribers, e.g. receiver nodes—not shown—or a bus termination 10, connected to it. Control lines 11 can be used by control electronics—not shown—to actuate the drivers 1 . . . 4. Suitable actuation of the drivers 1 . . . 4 allows a defined flow of current from node 5 to node 6 (or in the opposite direction) to be set. On the basis of the FlexRay(R) specification, the current direction determines the binary state “1” or “0” for a data bit which is to be transmitted via the bus. In the “1” state, a current flows from high-side driver 1 via line 8 to termination 10 (or to the receiver). From there, the current flows back via line 9 to low-side driver 4. When the “0” state is transmitted, the current flows from high-side driver 2 via line 9 to termination 9 and from there back via line 8 to low-side driver 3. Besides these two binary states, the FlexRay(R) specification is also known to comprise what is known as an “IDLE” state, which is obtained when the signal edges change between the binary states.

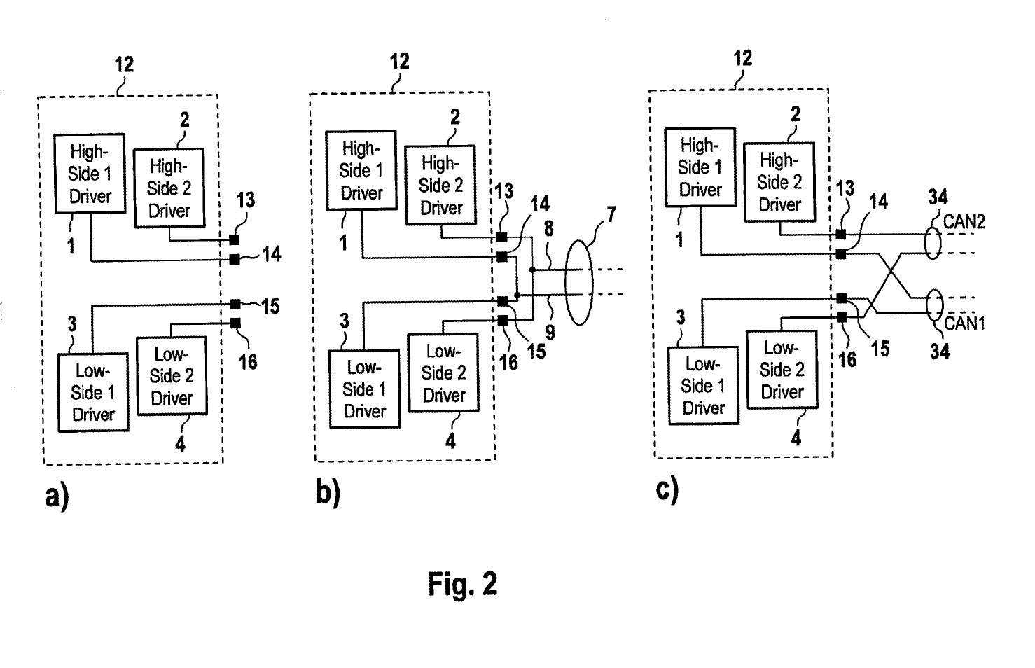

FIG. 2a shows the driver node as function block 12 (chip or module) generally with four bus connection terminals 13 . . . 16. Image section b) shows the interconnection of the terminals 13 . . . 16 of the function block 12 when used as a FlexRay(R) driver. Image section c) shows the interconnection of the terminals 13 . . . 16 of the function block 12 when used as a CAN driver, with two CAN drivers advantageously being able to be implemented for bus “CAN1” and “CAN2”.

The aforementioned drivers are respectively compiled from two individual high-side driver stages 1, 2 and two low-side driver stages 3, 4, for which the connections 13 . . . 16 of all four stages are routed out individually. External interconnection now makes it possible to present either a FlexRay driver by shorting pins 13 and 16 and pins 14 and 15, with the bus termination being situated between lines 8 and 9, or two CAN drivers by interconnecting the termination for bus “CAN1” between pins 14 and 15 and a termination for bus “CAN2” between pins 13 and 16. As an alternative to the option of stipulating the mode of operation by means of external interconnection, there is likewise preferably the option of automatically associating the external connections 13 to 16 using a coupling module, in which case the coupling module is particularly part of the circuit arrangement according to the invention.

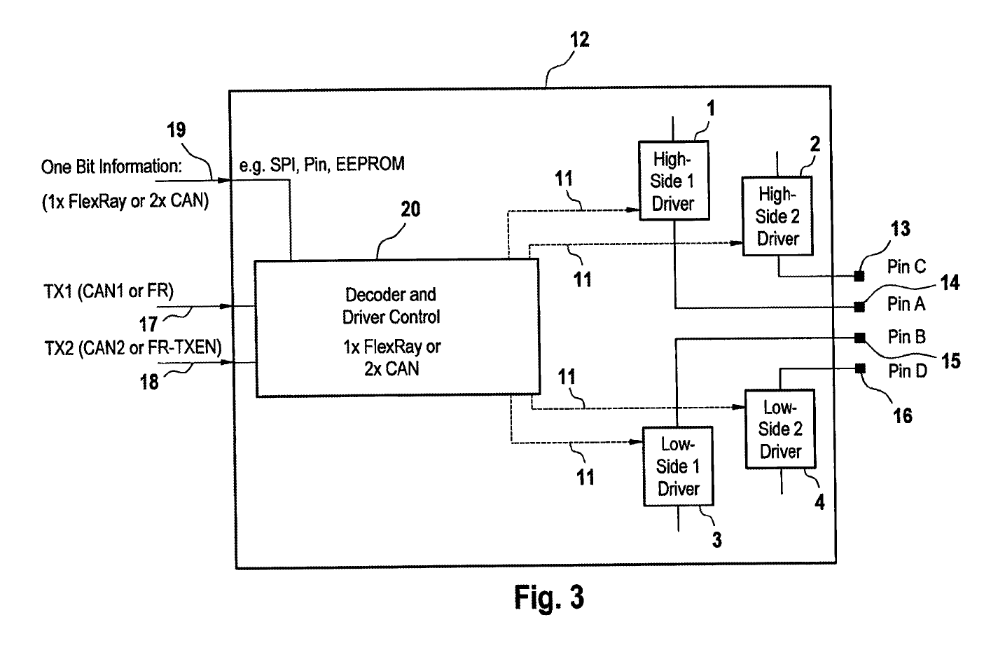

The driver module 12 in FIG. 3 comprises not only the driver stages shown in FIG. 2 but additionally a driver control block 20 which can be used to produce control signals 11 for the driver stages 1 . . . 4. On the side which faces the microcontroller—not shown—(the receiver is considered separately further below), module 12 has two input connections 17 and 18 which can be configured differently using control line 19. The lines 17 to 19 are connected to control block 20. Line 19 can be used to select two modes of operation for the control block 20. In “CAN” mode, line 17 has the functionality of the connection “TX” of a conventional CAN driver for the first CanBus “CAN1” (see FIG. 2). In this mode, line 18 is associated with the connection “TX” for the second CanBus “CAN2” (see FIG. 2). In the “FlexRay” mode of operation, line 17 is connected to the functionality of the standardized FlexRay(R) connection “FR”. Line 18 is then connected to the likewise standardized connection “FR-TXEN”. Control signal 19 for setting the modes can be provided by means of an SPI bus, for example, with a memory bit being set in the controlled block according to the mode of operation.

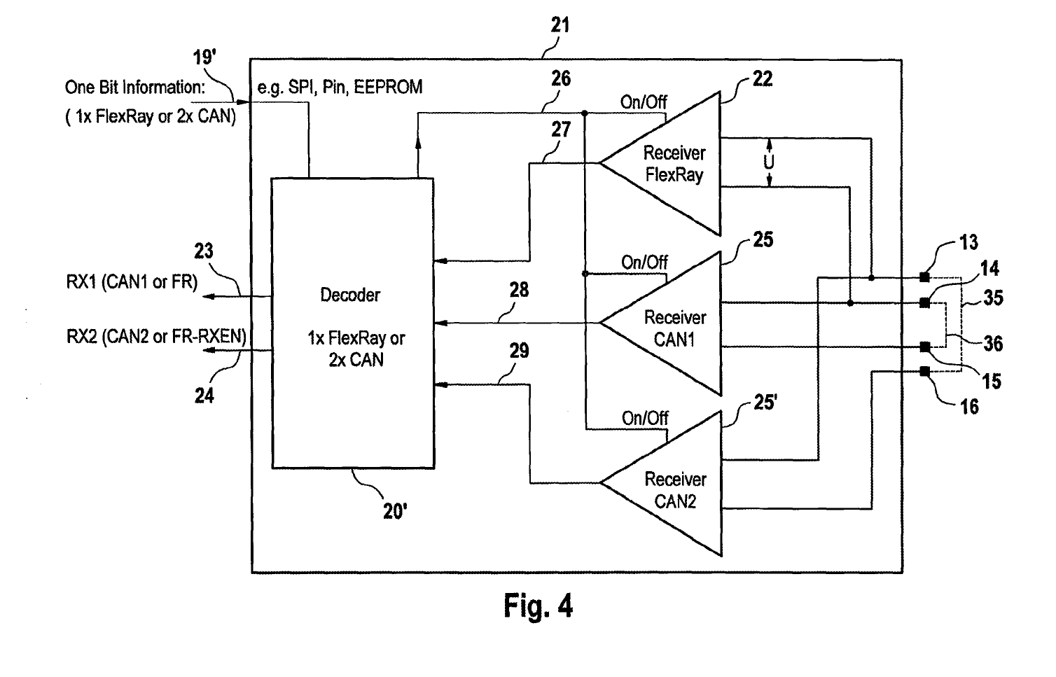

FIG. 4 shows a universally usable receiver module 21 which can be programmed in a similar manner to the driver (transmitter) in FIG. 3 by a receiver control block 20′ such that two modes of operation are available. Receiver 21 comprises a plurality of comparators 22, 25 and 25′ which form respective logic signals from difference voltages (e.g. voltage U on terminals 13 and 14). In the “FlexRay(R)” mode of operation shown, terminals 13 and 16 and also 14 and 15 are shorted (bridges 35 and 36). The difference voltages are then obtained from the levels which are on the bus lines 8 (BP) and 9 (BM). In the region of the comparators 22, 25 and 25′, the difference signal can also be compared with a reference voltage. If the difference voltage is above an upper switching threshold for the comparator 22, receiver 21 outputs a “dominant 1” signal, with simultaneous RxEN=0. If the difference voltage is below a lower switching threshold, the receiver outputs a “dominant 0” signal, with simultaneous RxEN=0.The outputs are made via lines 23 and 24.

Viewed in simple terms, a CAN receiver module essentially comprises a comparator (see also comparator 25) which is supplied with the difference voltage applied to terminals 14 (CAN1H) and 15 (CAN1L). If the difference voltage is above the upper switching threshold, the receiver outputs a signal “0” (dominant). If the difference voltage is below the lower switching threshold, the receiver outputs a “1” signal (recessive). The output is made via line 23 for the first CanBus and via line 24 for the second CanBus.

For each CAN input, the receiver 21 in FIG. 4 comprises a comparator 25 (“CAN1”) and 25′ (“CAN2”). These are connected to the input terminals “BP/CAN1H”, “BM/CAN1L” and “CAN2H, CAN2L”. As already mentioned, external interconnection (shorting) now makes it possible to implement either a FlexRay receiver in the first mode of operation or two CAN receivers in the second mode of operation.

The digital output signals 26 . . . 29 from the comparators 22, 25 and 25′ are forwarded via control block 20′ to the terminals 23, 24 for appropriate connection to the microcontroller. In the mode of operation as a FlexRay receiver, the signal RX1 is interpreted as RX and the signal RX2 is interpreted as RxEN. In the mode of operation as a CAN receiver, RX1 is interpreted as RX for CAN1 and RX2 is interpreted as RX for CAN2.

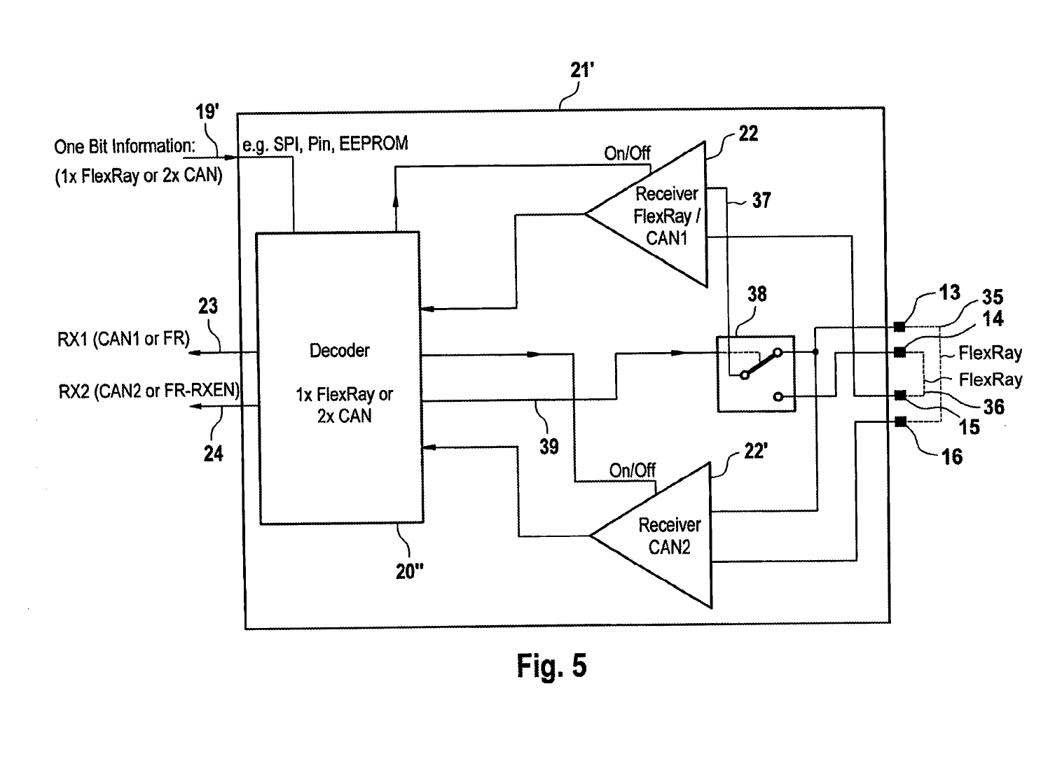

FIG. 5 shows a further circuit example for a universal receiver 21′ with two modes of operation. The bus signals are decoded by means of two comparators 22 and 22′, the inputs of which are electrically connected to bus terminals 13 . . . 16. In this case too, external interconnection of the terminals 13 . . . 16 needs to be performed in the “FlexRay(R)” mode of operation. The first input 37 of the comparator 22 is supplied to a changeover switch 38, so that this comparator input 37 can be connected to terminal 13 or to terminal 14 depending on the mode of operation. Control line 39, which is routed from decoder 20″ to changeover switch 38, takes the mode of operation as a basis for selecting the position of the switch 38. In “CAN” mode, terminals 14 and 15 are connected to bus line “CAN1” and terminals 14 and 16 are connected to bus line “CAN2”, and switch 38 sets up a connection from line 37 to terminal 13. In the mode of operation as a FlexRay(R) receiver, the terminals 13 and 16 are shorted, as are terminals 14 and 15 (dashed bridges 35 and 36). In this mode of operation, switch 38 sets up a connection from line 37 to terminal 14. Decoder 20″ comprises an SPI input 19′ which can be used to program the mode of operation of the decoder. In line with the programmed mode of operation, the digital outputs 23 and 24 are used to output either FlexRay(R) data (mode 1: outputs “FR” and “FR-RXEN”) or CAN data (mode 2:outputs “CAN1” and “CAN2”), with two CAN connections being available in the “CAN” mode of operation.

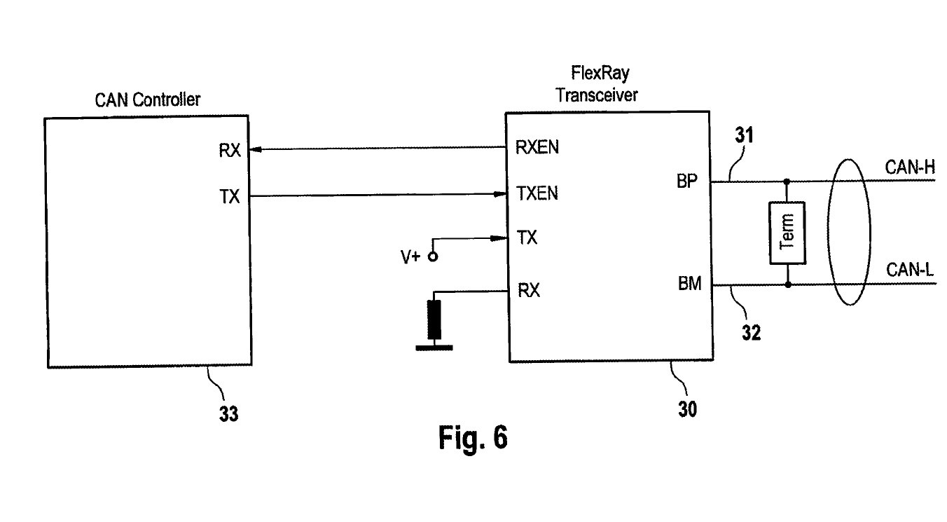

The conventional, commercially available FlexRay(R) transmission/reception chip 30 (FlexRay(R) transceiver) shown in FIG. 6 is used as a CAN chip merely by virtue of the actuation/interconnection being adjusted. This is surprisingly possible without excessive losses in terms of signal quality, by virtue of the bus lines “CAN-H” and “CAN-L” of a CAN network being connected to the FlexRay(R) connections 31 and 32. In addition, output “RXEN” of the FlexRay(R) transceiver 30 is electrically connected to input “RX” of the CAN controller 33, and input TXEN of the FlexRay(R) transceiver 30 is electrically connected to output “RX” of the CAN controller 33. The potential at input “TX” of the FlexRay transceiver 30 is connected to a positive voltage V₊. The potential at input “RX” of the FlexRay(R) transceiver 30 is connected to a reference-ground potential. This interconnection of the FlexRay transceiver 30 allows the functionality of a CanBus to be reproduced in the simplest way. The multiple use of the circuit provided per se for FlexRay allows a significant savings effect to be achieved in a controller which needs to be provided for both bus standards.

In at least one aspect, the invention therefore also relates to the use of a FlexRay(R) receiver as a CanBus receiver or of a FlexRay(R) transmitter as a CanBaus transmitter or of FlexRay(R) transceiver as a CanBus transceiver. The FlexRay(R) chip used for this is preferably used without alteration in comparison with FlexRay(R) chips used as standard, only the external interconnection of the connections having been changed in comparison with the interconnection provided in the FlexRay(R) standard.

On the basis of an example—not shown—of a combined transmitter/receiver circuit (transceiver) that can be used on a modular basis, said circuit comprises a combination of the transmission circuit 12 shown in FIG. 3 and the reception circuit shown in FIG. 4, which essentially comprises the comparators 22, 25 and 25′. The transmission and reception circuit elements are, in particular, combined to form a common module or electronic chip. An alternative implementation option for a combined transmission/reception circuit of this kind is achieved by combining the transmitter in FIG. 3 with the reception circuit shown in FIG. 5.

The control logic of blocks 20 and 20′ or 20″ is expediently combined to form a common block.

1-7. (canceled)

8. A transmission and/or reception circuit arrangement for the physical implementation of a motor vehicle data bus system having terminals for the connection of a data bus line and output terminals for the connection of a digital processing unit, wherein logic levels are applied to the output terminals on the basis of the bus data which are to be sent or received and wherein the circuit arrangement has one or more control lines which can be used to configure the behavior of the circuit arrangement, wherein
the circuit has a plurality of configurable modes of operation which are a different physical implementation of one or more logic states;
the circuit comprises electronic bit generation and/or bit reception circuit elements which are used in each mode of operation; and
changeover and/or structure means are present which can be used to change over the circuit arrangement between the modes of operation and/or to operate said circuit arrangement in different modes of operation.

9. The circuit arrangement as claimed in claim 8, wherein said circuit arrangement is a combined transmission and reception circuit, particularly a transceiver.

10. The circuit arrangement as claimed in claim 8, wherein said circuit arrangement comprises, for the purpose of sending data, two high-side drivers and two low-side drivers which are arranged such that in a first mode of operation a flow of current can be produced via the data bus, the logic states “0” and “1” being stipulated by the current direction, and in a second mode of operation a voltage or current level can be produced on the bus for a first logic state and a reference potential can be applied to the bus for a second logic state.

11. The circuit arrangement as claimed in claim 8, wherein said circuit arrangement comprises, for the purpose of reception via two signal lines in the first mode of operation, one or more comparators whose inputs are connected to the connections for the bus line and whose outputs are associated with one or more outputs of the circuit directly or indirectly by means of a control block.

12. The circuit arrangement as claimed in claim 8, wherein in a first mode of operation a FlexRay(R) bus is operated by the circuit and in a second mode of operation a CanBus is operated, wherein in the second mode of operation it is possible to connect two independent CANbuses which can be operated independently of one another.

13. The circuit arrangement as claimed in claim 8, wherein the control block outputs FlexRay(R) data at two data outputs in a first mode of operation and outputs a CAN data signal at one of the two data outputs and may output a further CAN data signal from a further CanBus at the other of the two data outputs in a second mode of operation.

14. The use of the circuit arrangement as claimed in claim 8 in a motor vehicle controller.

15. The use of the circuit arrangement as claimed in claim 8 in a braking controller and/or a controller for active and/or passive security systems.
